(19) United States
(12) Patent Application Publication
(10) Pub. No.: US 2022/0127895 A1
(43) Pub. Date: Apr. 28, 2022

(54) Powered Tailgate Opening System

(71) Applicant: Aptiv Technologies Limited, St. Michael (BB)

(72) Inventors: Mateusz Romaszko, Dublin (IE); Grzegorz Wyszynski, Dublin (IE); Wojciech Typrowicz, Dublin (IE); Krzysztof Holon, Dublin (IE)

(21) Appl. No.: 17/494,389

(22) Filed: Oct. 5, 2021

(30) Foreign Application Priority Data
Oct. 23, 2020 (EP) 20203721.4

(51) Int. Cl. E05F 15/73; E05F 15/40; B60J 5/10

(52) U.S. Cl. CPC E05F 15/73; E05F 15/40; B60J 5/101; E05Y 2900/546; E05Y 2400/40; E05Y 2400/44; E05Y 2400/54; E05Y 2400/32

(57) ABSTRACT

A powered tailgate opening system having object collision protection is disclosed for reducing the risk of collision with an object during opening of the tailgate. The opening system has an object distance sensor to sense a distance to an object during movement of the tailgate and an opening angle sensor for sensing an angle of opening of the tailgate. A memory stores limit distance values which vary according to different angles of opening of the tailgate and a controller controls a tailgate movement drive mechanism according to a determination of whether a sensed distance at a sensed angle of opening is less than the stored limit distance value for that sensed angle of opening.

### CROSS-REFERENCE TO RELATED APPLICATION

This application claims priority to European Patent Application Number 20203721.4, filed Oct. 23, 2020, the disclosure of which is hereby incorporated by reference in its entirety herein.

### BACKGROUND

When the tailgate of a motor vehicle is opened by a powered system, damage can occur if the tailgate is being driven and collides with objects such as walls, ceilings or humans which are located within the volume of movement swept by the tailgate (the sweep range) as it moves from a fully closed position towards a fully open position. It will be appreciated that the term tailgate includes the boot and other motor vehicle panels that close an opening of the vehicle.

A known powered tailgate opening system includes a distance sensor system oriented towards the rear of the vehicle. Such a distance sensor system normally provides distance warnings when parking or for determining the distance to following vehicles while driving. However, the powered tailgate opening system can also use data from the distance sensor system to determine if an object is located within the sweep range of the tailgate and controls the drive power for the drive of the tailgate accordingly.

Typically, a sensor of the distance sensor system of the powered tailgate opening system is located on the tailgate and the distance to an object is detected. A predetermined maximum distance extent of the tailgate during the sweep range is determined at an zero angle of opening. The opening system will then continue driving the tailgate to open if there is at least a minimum distance between the detected object distance and the maximum distance extent.

However, there is a problem with the known powered tailgate opening system in the case that the tailgate does not have a uniform profile. In such a case, setting such a minimum distance does not always prevent collision with an object.

### SUMMARY

The present disclosure relates to a powered tailgate opening system and in particular to a system having object collision protection for reducing the risk of a powered collision of the tailgate with an object during opening of the tailgate.

The present disclosure concerns a powered tailgate opening system having object collision protection which reduces the risk of collision with an object for tailgates which have an unusual profile.

According to a first aspect, there is provided a powered tailgate opening system comprising: one or more object distance sensors to sense a distance to an object during movement of the tailgate; an opening angle sensor for sensing an angle of opening of the tailgate; means for storing limit distance values which vary according to different angles of opening of the tailgate; a controller for controlling a tailgate movement drive mechanism according to a determination of whether a sensed distance at a sensed angle of opening is less than the stored limit distance value for that sensed angle of opening.

In one embodiment, the limit distance values for a given opening angle are calculated by: using the rotation matrix R(α) of equation 1 to establish the rotated shape of the tailgate:

$$( \begin{matrix}{\tilde{x}}_{i} \\ {\tilde{y}}_{i}\end{matrix} ) = R ( α ) ( \begin{matrix}{x}_{i} \\ {y}_{i}\end{matrix} ) \qquad Equation ( 1 )$$

calculating the maximal horizontal xₘₐₓ and vertical coordinates yₘₐₓ;

positioning a virtual wall and/or ceiling spaced from the tailgate by an error factor labelled margin:

x_{wall}=xₘₐₓ+margin

y_{ceiling}=yₘₐₓ+margin

calculating a limit distance value according to the distance value to the virtual wall and/or ceiling that would be detected by the one or more object distance sensors.

In particular, the rotation matrix R(a) can be based on four coordinates of the tailgate.

In another embodiment, powered tailgate opening system further comprises the tailgate movement drive mechanism.

### BRIEF DESCRIPTION OF THE DRAWINGS

Illustrative embodiments will now be described with reference to the accompanying drawings in which:

FIG. 1 illustrates a tailgate of a car having a uniform profile;

FIG. 2 illustrates steps in a procedure to establish distance limit values;

FIG. 3 illustrates a powered tailgate collision prevention system.

FIG. 4 illustrates a tailgate not having a uniform profile; and

FIG. 5 illustrates a graph of angle versus distance threshold (distance limit value) provided by the procedure of FIG. 2.

### DETAILED DESCRIPTION

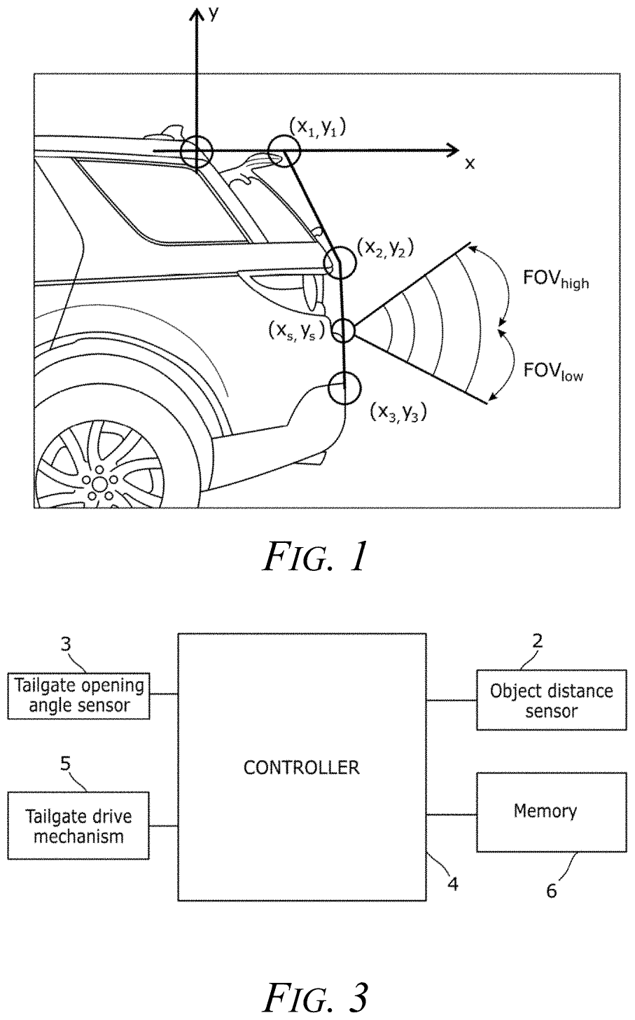

FIG. 1 illustrates a tailgate or liftgate of a car having a regular profile. A coordinate system based on the tailgate can be defined based on a frame of reference. In the present case, the origin of the x axis (horizontal to the ground) is at the hinge point at the top of the tailgate and the origin of the y axis (vertical, perpendicular to the ground) is also at the hinge point at the top of the tailgate.

Three coordinates in space (x₁,y₁), (x₂,y₂), and (x₃,y₃) for the tailgate are defined, with (x₃,y₃) being at the most remote edge of the tailgate. It will be apparent that more coordinates can be defined.

In addition, the opening angle of the tailgate can be defined based on a frame of reference. In the present case, an opening angle of zero is defined for when the tailgate is in a fully closed position. A tailgate opening angle sensor 3 (not shown in FIG. 1) is provided and located to sense the opening angle of the tailgate taking an opening angle of zero as just defined. The opening angle sensor can take many different forms, the details of which will be readily apparent to those skilled in the art.

A single object distance sensor 2 is provided and located on the tailgate, close to the most remote edge thereof, to move with the tailgate during its range of movement. The distance sensor has coordinates (xₛ₁,yₛ₁). The distance sensor has a sensing field of view, preferably a relatively higher field of view FOV_{high} and a relatively lower field of view FOV_{low}.

The object distance sensor 2 can sense any object within its sensing field of view and can establish the distance to the sensed object in known manner. It will be appreciated that the present disclosure is not limited to a single distance sensor and further sensors can be provided. Furthermore, the sensors can take many forms known to those skilled in the art, for example, radar, ultrasonic, LIDAR, optical, camera recognition.

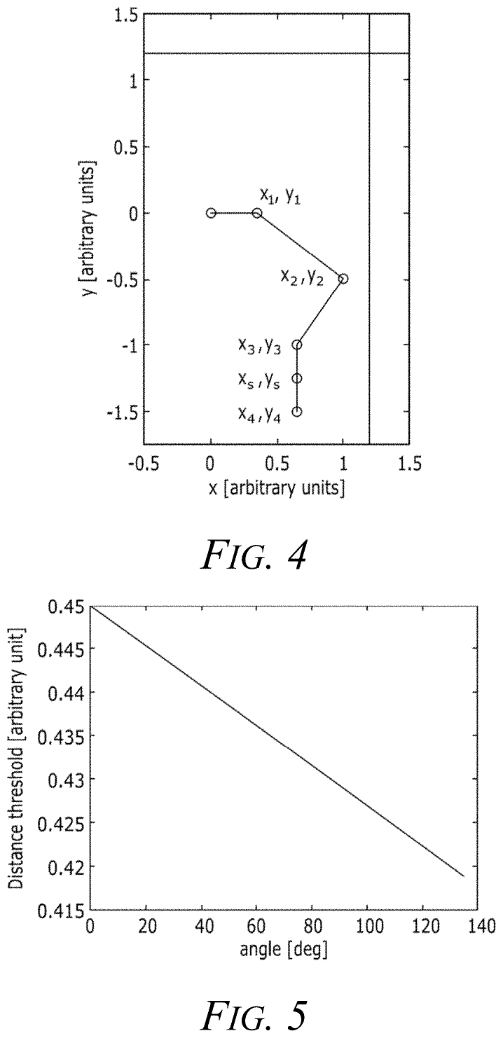

FIG. 4 shows the case of a tailgate having a profile which is not uniform. As can be seen, in this case there are four sets of coordinate (x₁,y₁), (x₂,y₂), (x₃,y₃) and (x₄,y₄) along with the distance sensor coordinates (xₛ₁,yₛ₁).

As noted, the prior art uses a predetermined maximum distance extent of the tailgate at a zero opening angle α and sets a minimum distance beyond this for an object so as to avoid a collision. However, this will not prevent the coordinate (x₂,y₂) encountering an object such as a ceiling.

Referring to FIG. 3, which illustrates an embodiment of a powered tailgate opening system 1 having an improved object collision protection. A controller 4 is provided which controls the drive of a tailgate drive mechanism 5 (not shown in FIG. 1) which is able to move the tailgate between a fully closed position and a fully open position. Such tailgate drive mechanisms can take many forms known to those skilled in the art.

A memory 6 is also provided. The memory of the present embodiment stores limit distance values or threshold values as a function of opening angle of the tailgate, with the size of the distance limit values reducing as the opening angle of the tailgate increases. The determination of the size of the distance limit values will be discussed hereinafter.

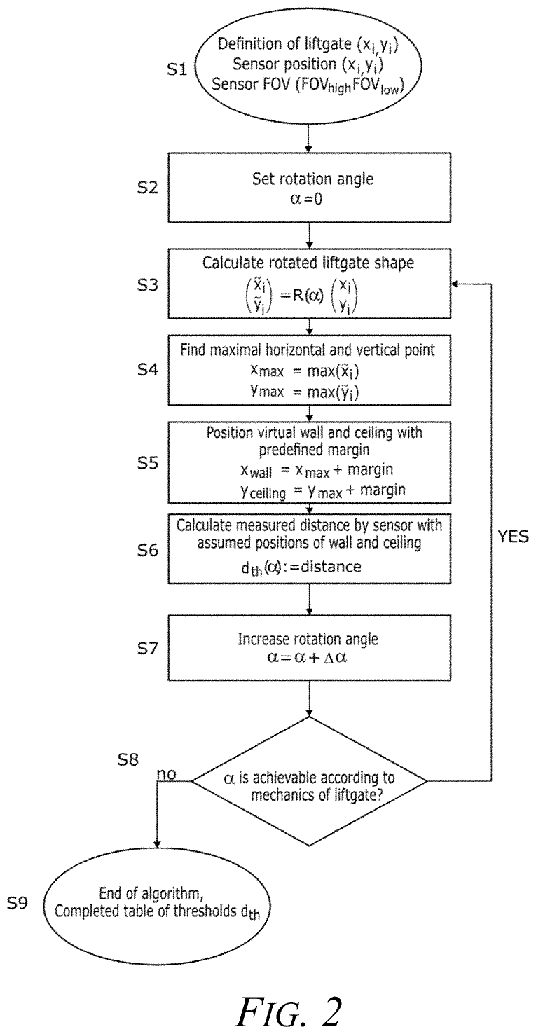

FIG. 2 illustrates steps in a procedure to establish the distance limit values to be stored in memory 6.

Initially, in step S1, the coordinates of the tailgate are defined, that is (x₁,y₁), (x₂,y₂), (x₃,y₃) and (x₄,y₄) together with the sensor coordinate (xₛ₁,yₛ₁) and the sensor field of view FOV (FOV_{high}, FOV_{low}).

Then, in step S2, the tailgate opening angle α is set to zero. Thereafter, in step S3, the rotated tailgate shape is established using a rotation matrix R(α)

$$( \begin{matrix}{\tilde{x}}_{i} \\ {\tilde{y}}_{i}\end{matrix} ) = R ( α ) ( \begin{matrix}{x}_{i} \\ {y}_{i}\end{matrix} )$$

From this, the maximal horizontal xₘₐₓ and vertical coordinates yₘₐₓ are found in step S4 for the current tailgate opening angle α. Then, in step S5 a virtual wall and ceiling are positioned which are spaced therefrom by an error factor labelled margin:

x_{wall}=xₘₐₓ+margin

y_{ceiling}=yₘₐₓ+margin

In step S6, at an initial angle of α₁ (initially set to zero), a calculation is made of the distance value that would be detected by the or each sensor to the wall or ceiling to give a value of dₜₕ₍₁₎ for that angle α₁. This value dₜₕ₍₁₎ is stored in the memory 6 as a distance limit value for that angle α₁. The angle of α is incremented in step S7 to α₂ and in step S8 an assessment is made as to whether that incremented angle α₂ is possible according to the tailgate drive mechanism 5.

If it is possible, the algorithm branches back to step S3 to repeat steps S3 to S6 and evaluates the new values of dₜₕ₍₂₎ the maximal horizontal xₘₐₓ and vertical coordinates yₘₐₓ, and evaluates another value of dₜₕ₍₂₎ for that angle α₂. This value of dₜₕ₍₂₎ is stored in the memory 6 as a distance limit value for angle α₂.

The steps S3 to S7 are repeated until the value of α is not possible according to the tailgate drive mechanism 5 and the procedure branches to step S8 and ends. Consequently, a look up table of values of distance limit value dₜₕ against angle α can be obtained. It will be appreciated that as the angle α increases the value of the distance limit value decreases.

FIG. 5 illustrates a graph of angle versus distance threshold (distance limit values) provided by the procedure of FIG. 2 for the tailgate of FIG. 4. As these values are evaluated for each opening angle α, the powered tailgate opening system of FIG. 3 is able to prevent the coordinate (x₂,y₂) encountering an object such as a ceiling. It also enables a greater accuracy of detection of objects that might be encountered during opening of the tailgate.

In operation to open the tailgate, the controller 4 receives an open instruction. At this point, the controller 4 starts an opening process in which it checks that the distance value being sensed by the distance sensor 2 is greater than the distance limit value in the memory 6 for the angle corresponding to that currently sensed by the angle sensor 3. Assuming this to be the case, the controller 4 will activate the tailgate drive mechanism 5 to open the tailgate.

The opening process continues with the controller 4 continuing to check that the distance value being sensed by the distance sensor 2 is greater than the particular distance limit value in the memory 6 for the particular angle corresponding to that currently sensed by the angle sensor 3. Provided the distance value being sensed by the distance sensor remains greater, the controller 4 continues to open the tailgate. However, if the distance value become less, the controller 4 deactivates the tailgate drive mechanism to stop opening of the tailgate.

In this way, the controller of the present embodiment dynamically monitors the distance value to any object during opening of the tailgate and uses a particular distance limit value which is set in the memory for the particular angle of opening of the tailgate rather than a single minimum threshold value throughout the sweep range of the tailgate which was established just at zero angle of opening of the tailgate.

Consequently, increased accuracy of opening of the tailgate is provided and reduces the likelihood that the tailgate could physically contact an object. This is particularly helpful in the case when the tailgate has an unusual shape.

It will be understood that the embodiments illustrated above show applications only for the purposes of illustration. In practice, embodiments may be applied to many different configurations, the detailed embodiments being straightforward for those skilled in the art to implement.

What is claimed is:

1. A powered tailgate opening system comprising:
one or more object distance sensors configured to sense a distance to an object during movement of the tailgate;
an opening angle sensor configured to sensing an angle of opening of the tailgate;
means for storing limit distance values that vary according to different angles of opening of the tailgate; and
a controller configured to control a tailgate movement drive mechanism according to a determination of whether a sensed distance at a sensed angle of opening of the tailgate is less than the limit distance values stored for that sensed angle of opening of the tailgate.

2. The powered tailgate opening system according to claim 1, wherein the limit distance values stored for that sensed angle of opening of the tailgate are calculated by:
using a rotation matrix for that sensed angle of opening of the tailgate to establish a rotated shape of the tailgate;
calculating a maximal horizontal coordinate and maximal vertical coordinate;
positioning a virtual wall or ceiling spaced from the tailgate by an error factor applied to each of the maximal horizontal coordinate and the maximal vertical coordinate; and
calculating the limit distance values for that sensed angle of opening of the tailgate according to a distance value to the virtual wall or ceiling that is in detection range of the one or more object distance sensors.

3. The powered tailgate opening system according to claim 2, wherein the rotation matrix is based on more than three coordinates of the tailgate.

4. The powered tailgate opening system according to claim 3, wherein the rotation matrix is based on five or six coordinates of the tailgate.

5. The powered tailgate opening system according to claim 1, further comprising the tailgate movement drive mechanism.

6. The powered tailgate opening system according to claim 1, wherein the controller is configured to control the tailgate movement drive mechanism according to the determination to prevent a collision with the object when causing the movement of the tailgate.

7. The powered tailgate opening system according to claim 1, wherein the controller is configured to control the tailgate movement drive mechanism according to the determination to reduce a likelihood of the tailgate physically contacting the object when causing the movement of the tailgate.

8. A system comprising a controller configured to control a tailgate movement drive mechanism for a tailgate of a vehicle, the controller configured to:
sense, using one or more object distance sensors, a distance to an object during movement of the tailgate;
sense, using an opening angle sensor, a given angle of opening of the tailgate;
store limit distance values that vary according to different angles of opening of the tailgate; and
determination whether the distance at the given angle of opening of the tailgate is less than the limit distance values stored for the given angle of opening of the tailgate; and
control the tailgate movement drive mechanism according to the determination to prevent a collision with the object when causing movement of the tailgate.

9. The system of claim 8, wherein the controller is further configured to calculate the limit distance values stored for the given angle of opening of the tailgate based on a rotation matrix for the given angle of opening of the tailgate to establish a rotated shape of the tailgate for the given angle of opening of the tailgate.

10. The system of claim 9, wherein the controller is further configured to calculate the limit distance values stored for the given angle of opening of the tailgate based further on a maximal horizontal coordinate for the given angle of opening of the tailgate and a maximal vertical coordinate for the given angle of opening of the tailgate.

11. The system of claim 10, wherein the controller is further configured to calculate the limit distance values stored for the given angle of opening of the tailgate based further on a position of a virtual wall or ceiling spaced from the tailgate with an error factor applied to each of the maximal horizontal coordinate and the maximal vertical coordinate, and a distance value to the virtual wall or ceiling that is in detection range of the one or more object distance sensors.

12. The system of claim 9, wherein the rotation matrix is based on more than three coordinates of the tailgate.

13. The system of claim 12, wherein the rotation matrix is based on five or six coordinates of the tailgate.

14. The system of claim 8, wherein the controller is configured to control the tailgate movement drive mechanism according to the determination to reduce a likelihood of the tailgate physically contacting the object when causing the movement of the tailgate.

15. A system for controlling a tailgate movement drive mechanism for a tailgate of a vehicle, the system comprising:
means for sensing a distance to an object during movement of the tailgate;
means for sensing a given angle of opening of the tailgate;
means for storing limit distance values that vary according to different angles of opening of the tailgate;
means for determining whether the distance at the given angle of opening of the tailgate is less than the limit distance values stored for the given angle of opening of the tailgate; and
means for controlling the tailgate movement drive mechanism based on whether the distance at the given angle of opening of the tailgate is less than the limit distance values stored for the given angle of opening of the tailgate to prevent a collision with the object when causing movement of the tailgate.

16. The system of claim 15, wherein the means for controlling further comprise:
means for calculating the limit distance values stored for the given angle of opening of the tailgate based on a rotation matrix for the given angle of opening of the tailgate to establish a rotated shape of the tailgate for the given angle of opening of the tailgate.

17. The system of claim 16, wherein the means for calculating the limit distance values stored for the given angle of opening of the tailgate comprises means calculating the limit distance values based further on a maximal horizontal coordinate for the given angle of opening of the tailgate and a maximal vertical coordinate for the given angle of opening of the tailgate.

18. The system of claim 16, wherein the rotation matrix is based on more than three coordinates of the tailgate.

19. The system of claim 18, wherein the rotation matrix is based on five or six coordinates of the tailgate.

20. The system of claim 15, wherein the means for controlling further comprise means for controlling the tailgate movement drive mechanism according to the means for determining whether the distance at the given angle of opening of the tailgate is less than the limit distance values stored for the given angle of opening of the tailgate to reduce a likelihood of the tailgate physically contacting the object when causing the movement of the tailgate.
